(19) United States
(12) Patent Application Publication
(10) Pub. No.: US 2007/0232330 A1
(43) Pub. Date: Oct. 4, 2007

(54) Method and apparatus of modifying a paging slot cycle index value

(75) Inventor: Murali Ranganathan, Phoenix, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC.

(21) Appl. No.: 11/395,489

(22) Filed: Mar. 30, 2006

(51) Int. Cl. H04Q 7/20

(52) U.S. Cl. 455/458

(57) ABSTRACT

A method and apparatus of modifying a paging slot cycle index value used by a mobile station in a wireless communication system may include in a paging area, a carrier site receiving a plurality of paging request messages for the mobile station, where the carrier site utilizes at least one paging channel. A paging channel utilization of the at least one paging channel is measured and if the paging channel utilization exceeds a paging channel utilization threshold, it is determined if any of the plurality of paging request messages are being discarded. If any of the plurality of paging request messages are being discarded, the paging slot cycle index value for the carrier site is reduced allowing quicker opportunities to deliver messages to the mobile station.

### BACKGROUND OF INVENTION

Paging channel congestion is common in wireless communication systems where paging channels are used to send paging requests for locating a mobile station and for transmitting mobile directed or broadcast messages to mobile station(s) located over a wide coverage area. Typically, a large amount of congestion involves paging requests sent to an area where there is a mixture of single carrier and multi-carrier sites. Given the nature of the paging request distribution, the single carrier sites have to carry the same load as the multi-carrier sites, thus increasing the paging request loss since single carrier sites are running at full capacity. This has the disadvantage of decreasing the paging success rate and degrading overall performance of a wireless communication system.

Thus, a need exists to improve the paging success rate in single carrier or low-number carrier sites that does not involve expensive infrastructure improvements.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a wireless communication system in accordance with an exemplary embodiment of the present invention;

FIG. 2 representatively illustrates a wireless communication system in accordance with another exemplary embodiment of the present invention;

FIG. 3 representatively illustrates a network access node in accordance with an exemplary embodiment of the present invention;

FIG. 4 representatively illustrates a mobile station (MS) in accordance with an exemplary embodiment of the present invention; and

FIG. 5 representatively illustrates a logic flow diagram in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, an object code, a shared library/dynamic load library and/or other sequence of instructions designed for execution on a computer system. A component may include a computer program, software application, or one or more lines of computer readable processing instructions.

Software blocks that perform embodiments of the present invention can be part of computer program modules comprising computer instructions, such control algorithms that are stored in a computer-readable medium such as memory. Computer instructions can instruct processors to perform any methods described below. In other embodiments, additional modules could be provided as needed.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

A wireless communication system in accordance with the present invention is described in terms of several preferred embodiments, and particularly, in terms of a wireless communication system operating in accordance with at least one of several standards. These standards may include analog, digital or dual-mode communication system protocols such as, but not limited to, Advanced Mobile Phone System (AMPS), Narrowband Advanced Mobile Phone System (NAMPS), Global System for Mobile Communications (GSM), Enhanced Data-rate for GSM Evolution (EDGE), Frequency Division Multiple Access (FDMA), Time Division Multiple Access (TDMA) digital cellular, Code Division Multiple Access (CDMA) digital cellular, demand assignment schemes (DA/TDMA, DA/CDMA, DA/FDMA), Wideband Code Division Multiple Access (WCDMA), CDMA 2000, Personal Communications System (PCS), 3G, 3GPP, 3GPP2, Universal Mobile Telecommunications System (UMTS), 802.16 and variations and evolutions of these protocols.

Wireless communication systems are well known and consist of many types including land mobile radio, cellular radiotelephone (inclusive of analog cellular, digital cellular, personal communication systems (PCS) and wideband digital cellular systems), and other communication system types. In cellular radiotelephone communication systems, for example, a number of communication cells are typically comprised of one or more Base Transceiver Stations (BTSs) coupled to one or more Base Station Controllers (BSCs) or Central Base Station Controllers (CBSCs) and forming a network access node. The BSCs or CBSCs are, in turn, coupled to a Mobile Switching Center (MSC) which provides a connection between the network access node and an external network, such as a Public Switched Telephone Network (PSTN), as well as interconnection to other network access nodes. Each BTS provides communication services to a mobile station (MS) located in a coverage area serviced by the BTS via a communication resource that includes a forward link for transmitting signals to, and a reverse link for receiving signals from, the MS.

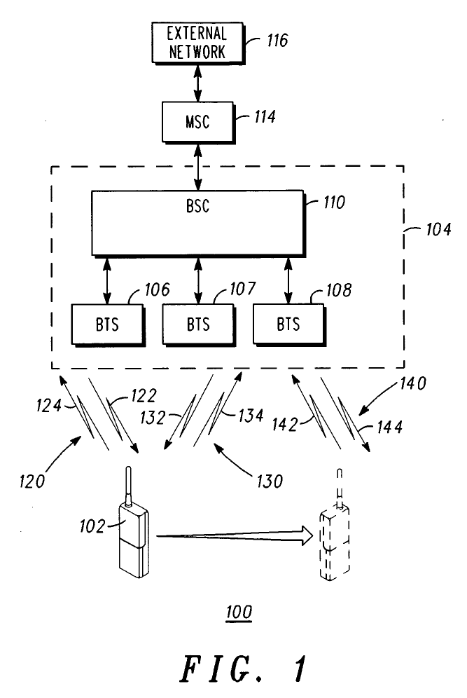

FIG. 1 representatively illustrates a wireless communication system 100 in accordance with an exemplary embodiment of the present invention. Wireless communication system 100 includes a network access node 104 comprising multiple BTSs 106-108 that are each coupled to a BSC 110. Network access node 104 is coupled to an MSC 114 and MSC 114 is in turn coupled to an external network 116 and provides a communication link between the external network, or other network access nodes, and network access node 104. Wireless communication system 100 further includes a MS 102 that concurrently is in active communication with each of BTS 106, 107 and 108. That is, MS 102 is in ‘soft-handoff’ with each of BTSs 106, 107 and 108 and each of BTS 106, BTS 107 and BTS 108 is a member of an ‘active sef’ of MS 102. As members of the active set of MS 102, each BTS of BTSs 106, 107 and 108 concurrently maintains a respective wireless communication link 120, 130, 140 with the MS 102. Each wireless communication link 120, 130, 140 includes a respective forward link 122, 132, 142 for conveyance of signals to MS 102 and a respective reverse link 124, 134, 144 for receipt of signals from the MS 102.

Each BTS 106, 107, 108 in the active set of MS 102 conveys the same bearer traffic to, and receives the same bearer traffic from, the MS 102. By providing multiple BTSs that concurrently convey same signals to, and receive same signals, from MS 102, wireless communication system 100 enhances the likelihood that the MS 102 will receive an acceptable quality signal from network access node 104 and that the network access node 104 will receive an acceptable quality signal from the MS 102. For example, when each BTS of BTSs 106, 107, 108 receives a same frame from MS 102, the BTS determines whether the received frame is acceptable or erroneous and forwards the frame, and an accompanying indicator of whether the frame is acceptable, that is, good, or erroneous, to BSC 110. BSC 110 then selects a version of the received frame from among the versions received from BTSs 106, 107, 108 and forwards the selected version to MSC 114.

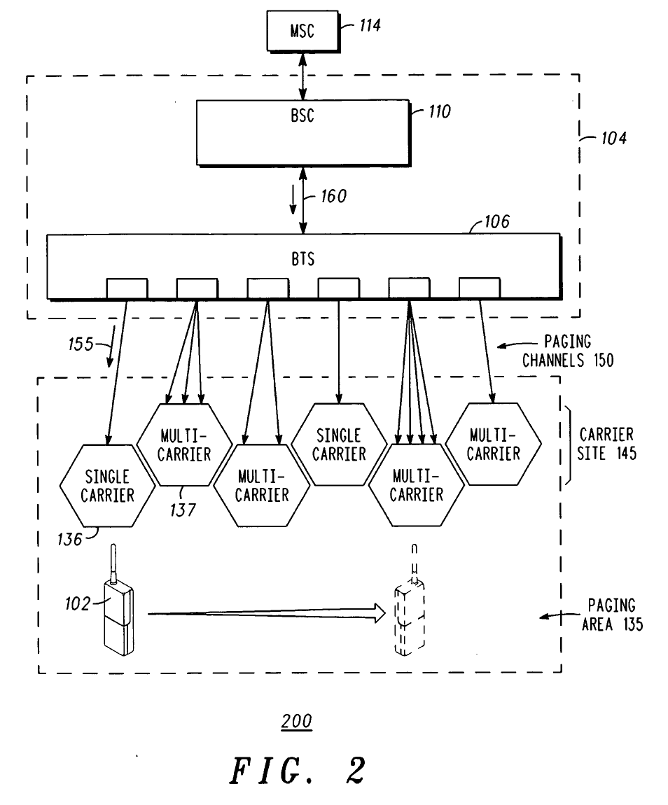

FIG. 2 representatively illustrates a wireless communication system 200 in accordance with another exemplary embodiment of the present invention. The wireless communication system 200 is similar to the wireless communication system 100 of FIG. 1, except that only one BTS 106 is shown for clarity. In FIG. 2, BTS 106 is shown as providing coverage in paging area 135. In effect, MS 102 entering paging area 135 communications with network access node 104 via BTS 106.

Paging area 135 may comprise any number of carrier sites 145. In an embodiment, a carrier site 145 may be a portion of paging area 135 that is served by one or more distinct paging channels 150. The number of paging channels 150 in a carrier site 145 may often be a function of the number of frequency bands allotted to a given carrier site 145. A frequency band is the bandwidth about which calls in a given carrier site may be spread using TDMA, CDMA, OFDM, and the like. In CDMA, each carrier band is approximately 1.25 MHz. This is exemplary and other frequency band sizes are within the scope of the invention.

A multi-carrier site 137 may have more than one frequency band allotted due to a large volume of traffic in that particular carrier site. For example, in the embodiment, shown, multi-carrier site 137 has three paging channels allotted. A multi-carrier site 137 may be any carrier site 145 that has one paging channel for each carrier. In one embodiment, a carrier site with only one frequency band may have more than one paging channel allotted, which is still a multi-carrier site 137. In another embodiment, a carrier site with one frequency band may only have one paging channel allotted to it, which is a single carrier site 136. A single carrier site 136 may be used where there is less traffic or where fewer MSs 102 may be found at any given time as compared to a multi-carrier site 137. The number of carriers per site is allocated based on the need for traffic carrying capability rather than the capacity required for paging operations.

MS 102 may be paged while in paging area 135. A plurality of paging request messages 160 may come from MSC 114 to BTS 106 as each of plurality of paging request messages 160 may include a paging area identifier in the header. Plurality of paging request messages 160 may be hashed across available carriers within the multi-carrier sites 137 based on which carrier MS 102 may be listening to. Plurality of paging request messages 160 sent to single carrier sites 136 will always be sent over the single carrier since all mobile stations will be listening to that single carrier. Since it is not known which carrier site 145 MS 102 is located, plurality of paging request messages 160 are channeled to each carrier site 145.

For multi-carrier sites 137, the plurality of paging request messages 160 are spread among the paging channels 150 for that carrier site. For example, in multi-carrier site 137, the number of plurality of paging request messages 160 is spread over three paging channels 150. So if there are one hundred paging request messages 160, each paging channel 150 would transmit approximately thirty three paging request messages 160 to multi-carrier site 137.

However, for a single carrier site 136, the single paging channel 150 must carry all of the plurality of paging request messages 160. So if there are one hundred paging request messages 160, paging channel 150 for single carrier site 136 will attempt to carry all one hundred paging request message 160. It is clear that the likelihood of building up a queue of paging request messages 160 in a single carrier site 136 is greater than in a multi-carrier site 137. Further, it is clear that for a given amount of paging request messages 160, the likelihood of overloading the paging channel in a single carrier site 136 is much greater than in a multi-carrier site 137. If the single carrier site 136 is overloaded, there is a chance that paging request messages 160 may be discarded, for example, by becoming stale or by overloading the available queue capacity. This may result in a lower paging success rate for wireless communication system 200.

To address the above-discussed deficiencies, it is a primary object of the present invention to provide, for use in a wireless communication system, a BTS capable of modifying the slot cycle index (SCI) value used by one or mobile stations 102 communicating with the BTS 106. According to an advantageous embodiment, the BTS comprises a paging slot cycle index controller capable of causing the BTS to transmit a paging slot cycle index control message 155 to one or more mobile stations, wherein the paging slot cycle index control message 155 includes an SCI value to be used by one or more mobile stations when it enters a particular carrier site.

In an embodiment, MS 102 enters an idle state when MS 102 is turned on, is synchronized with wireless communication system 200, and has no calls in progress. During the idle state, MS 102 actively listens to a paging channel 150 for information. This information includes overhead messages, such as system parameter messages, as well as messages directly addressed to MS 102 from a BTS 106.

During the idle state, MS 102 may communicate with BTS 106 in a non-slotted or a slotted mode of a slotted cycle index (SCI). A typical paging channel slot is an 80-millisecond time slot within a paging slot cycle. The paging slot cycle ranges from 16 time slots (1.28 seconds) to 2048 time slots (163.84 seconds). In the unslotted mode, MS 102 monitors all paging channel slots for messages from BTS 106. In the slotted mode, the MS 102 only monitors a selected subset of the paging channel slots for messages from BTS 106. During time periods when the MS 102 is not monitoring the selected subset of paging channel slots, power is turned off in the MS RF receiver in order to conserve batter life. MS 102 may extend the battery supply operating life by entering a slotted mode of operation with the BTS because the MS 102 receiver consumes power only during selected slot cycles rather than across the entire paging cycle.

In earlier wireless networks, such as Release B of cdma2000 (i.e., IS-2000-B), MS 102 could select a full slot cycle index, r, between 0 and 7 (i.e., 000-111). The slot cycle index, r, gives the period, P, of the slotted mode of operation according to the equation:
P=(2)^{r}×1.28 seconds.

Thus, for example, if the full slot cycle index, r, is 0, the period of the slotted mode is 1.28 seconds. If the full slot cycle index, r, is 7, the period of the slotted mode is 163.84 seconds.

In order to allow increased opportunities to deliver paging messages 160 with lower delay and paging loss rates, the latest generation of mobile stations are capable of entering a reduced slot cycle mode (or negative slot cycle mode) when the mobile station is in a slotted mode of operation. In reduced slot cycle mode, the mobile station selects a reduced slot cycle index, r, between −4 and 7. As before, the slot cycle index, r, gives the period, P, of the slotted mode of operation according to the equation:
P=(2)^{r}×1.28 seconds.

Because the slot cycle index, r, can be a negative value, slot cycle periods of less than 1.28 seconds are possible. For example, if the reduced slot cycle index, r, is −4, the reduced slot cycle period of the slotted mode is 80 milliseconds. If the reduced slot cycle index, r, is −3, the reduced slot cycle period of the slotted mode is 160 milliseconds. If the reduced slot cycle index is −2, the reduced slot cycle period of the slotted mode is 320 milliseconds, and so forth.

In an embodiment, a paging SCI value may be set at a baseline value, for example and without limitation, a value of 2. This allows plurality of paging request messages 160 to be processed in a single carrier site 136 every 5.12 seconds by MS 102. This baseline paging SCI value may be a maximum paging SCI value allowed by BTS 106 or MS 102 and it may change depending on any set of conditions or priorities. By reducing the paging SCI value, more of plurality of paging request messages 160 may be sent via paging channel 150 in a given period of time. In other words, MS 102 monitors the paging channel 150 during more of the time slots of the paging cycle. For example, if paging SCI value is reduced to 1, a paging request message may be sent to MS 102 every 1.28 seconds, and so on into the negative slot cycle values. If paging SCI value is reduced to unslotted, then MS 102 constantly monitors for paging request messages during all time slots. While reducing the paging SCI value of MS 102 may cause a drain on the battery of MS 102, this is a trade-off that is often worthwhile given that otherwise, MS 102 may miss the paging request message all together.

In an embodiment, BTS 106 may measure the paging channel utilization of one or more of the paging channels associated with a given carrier site. For example, BTS 106 may measure the paging channel utilization of a single paging channel associated with single carrier site 136. Also, BTS 106 may measure the paging channel utilization of each paging channel associated with a multi-carrier site 137. Paging channel utilization may be how much capacity of paging channel is being used by a given amount of plurality of paging request messages being sent over one or more paging channels.

If the paging channel utilization meets or exceeds a paging channel utilization threshold, then BTS 106 may check to see if any of plurality of paging request messages 160 are being discarded. Paging channel utilization threshold may be any percentage of capacity that paging channel 150 is operating. For example and without limitation, paging channel utilization threshold may be 70%, 80%, and the like. Any value or criteria of paging channel utilization threshold may be used to trigger BTS 106 to check if any of plurality of paging request messages are being discarded.

If both conditions are met, in that utilization is above utilization threshold and any or a certain number of paging request messages are being discarded, it may be indicative that paging channel 150 is overloaded and a paging request message may not reach MS 102. If the currently used paging SCI value that BTS 106 is having MS 102 use is above a minimum paging SCI value, then BTS 106 may send paging SCI control message 155 to one or more MSs in the corresponding carrier site to have them use a reduced paging SCI value. For example, if MS 102 is currently using a paging SCI value of 2 and the minimum paging SCI value is −2, then BTS 106 may send paging SCI control message to MS 102 to reduce paging SCI value from 2 to 1, or to any other lower number of SCI paging value above −2. This will allow MS 102 to listen for paging request messages during more time slots and relive the backlog of paging request messages in queue at BTS 106. The minimum paging SCI value may be set at any desired value, for example −4, −3, unslotted, and the like.

In order to conserve the battery power of MS 102, if no discards of paging request messages 160 are occurring, then BTS 106 may send out paging SCI control message 155 to have MS 102 use an increased paging SCI value. For example, if the currently used paging SCI value of MS 102 is 1, then paging SCI control message 155 may have MS increase paging SCI value to 2. In an embodiment, if MS 102 is already operating at a baseline or maximum paging SCI value, then no increase of paging SCI value may occur. In another embodiment, MS 102 may use an ever increasing value of paging SCI value until discards occur as described above or a baseline paging SCI value is reached.

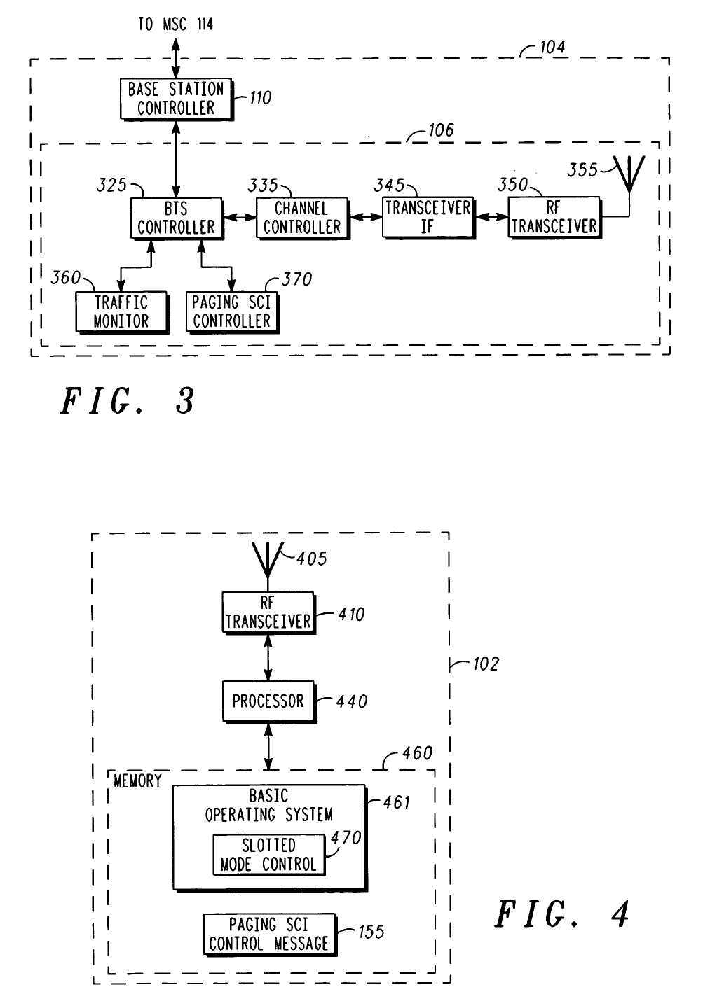

FIG. 3 representatively illustrates a network access node 104 in accordance with an exemplary embodiment of the present invention. Network access node 104 comprises base station controller (BSC) 110 and base transceiver station (BTS) 106. Base station controllers and base transceiver station were described previously in connection with FIG. 1. BTS 106 comprises BTS controller 325, channel controller 335, transceiver interface (IF) 345, RF transceiver unit 350, and antenna array 355. Channel controller 335 may comprise a plurality of channel elements. BTS 106 also comprises traffic monitor 360 and paging SCI controller 370.

BTS controller 325 comprises processing circuitry and memory capable of executing an operating program that communicates with BSC 110 and controls the overall operation of BTS 106. Under normal conditions, BTS controller 325 directs the operation of channel controller 335 that performs bi-directional communications in the forward links and the reverse links. Transceiver IF 345 transfers the bi-directional channel signals between channel controller 335 and RF transceiver unit 350.

Antenna array 355 transmits forward link signals received from RF transceiver unit 350 to mobile stations in the coverage area of BTS 106. Antenna array 355 also sends to RF transceiver 350 reverse link signals received from mobile stations in the coverage area of BTS 106. In a preferred embodiment of the present invention, antenna array 355 is a multi-sector antenna, such as a three-sector antenna in which each antenna sector is responsible for transmitting and receiving in a 120.degree arc of coverage area. Additionally, RF transceiver 350 may contain an antenna selection unit to select among different antennas in antenna array 355 during transmit and receive operations.

According to an exemplary embodiment of the present invention, traffic monitor 360 and paging SCI controller 370 are capable of modifying the paging SCI value used by one or more MSs 102. Traffic monitor 360 is associated with BTS controller 325 and monitors the number of mobile stations handled by BTS 106, the amount of voice and data traffic handled, and the number of mobile stations operating in using which paging SCI values.

In FIG. 3, paging SCI controller 370 and traffic monitor 360 are associated with BTS 106. It should be understood that this configuration is by way of illustration only and should not be construed to limit the scope of the present invention. Those skilled in the art will understand that in other embodiments, paging SCI controller 370 and traffic monitor 360 may be associated with BSC 110. In still other embodiments, paging SCI controller 370 and traffic monitor 360 may be associated with both BTS 106 and BSC 110.

According to an advantageous embodiment of the present invention, BTS 106 is further capable of selectively assigning particular MSs to different paging SCI values, so that MSs in the paging area or carrier site may operate at different paging SCI values. To accomplish this, paging SCI controller 370 causes BTS controller 325 to transmit to one or more target mobile stations special-purpose paging SCI control messages 155 in which different paging SCI values are specified for different mobile stations.

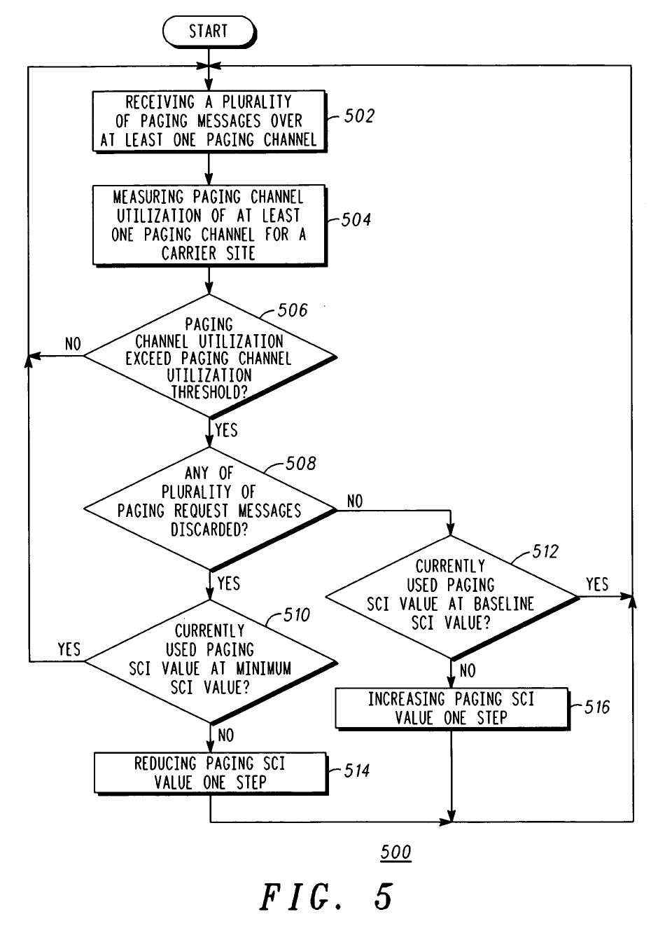

FIG. 4 representatively illustrates a mobile station (MS) 102 in accordance with an exemplary embodiment of the present invention. MS 102 comprises antenna 405, radio frequency (RF) transceiver 410, processor 440 and memory 460. Memory 460 further comprises basic operating system (OS) program 461, slotted mode control algorithm 470.

Radio frequency (RF) transceiver 410 receives from antenna 405 an incoming RF signal transmitted by a BTS of wireless communication system 100. Radio frequency (RF) transceiver 410 down-converts the incoming RF signal to produce an intermediate frequency (IF) or a baseband signal. The IF or baseband signal is sent to receiver (RX) processing circuitry (not shown) that produces a processed baseband signal by filtering, decoding, and/or digitizing the baseband or IF signal. Receiver (RX) processing circuitry transmits the processed baseband signal to a speaker (i.e., voice data) or to processor 440 for further processing (e.g., web browsing).

Transmitter (TX) processing circuitry (not shown) receives analog or digital voice data from a microphone or other outgoing baseband data (e.g., web data, e-mail, interactive video game data) from processor 440. Transmitter (TX) processing circuitry encodes, multiplexes, and/or digitizes the outgoing baseband data to produce a processed baseband or IF signal. Radio frequency (RF) transceiver 410 receives the outgoing processed baseband or IF signal from transmitter (TX) processing circuitry. Radio frequency (RF) transceiver 410 up-converts the baseband or IF signal to a radio frequency (RF) signal that is transmitted via antenna 405.

In an advantageous embodiment of the present invention, processor 440 is a microprocessor or microcontroller. Memory 460 is coupled to processor 440. According to an advantageous embodiment of the present invention, part of memory 460 comprises a random access memory (RAM) and another part of memory 460 comprises a Flash memory, which acts as a read-only memory (ROM).

Processor 440 executes basic operating system (OS) program 461 stored in memory 460 in order to control the overall operation of MS 102. In one such operation, processor 440 controls the reception of forward link signals and the transmission of reverse link signals by radio frequency (RF) transceiver 410, receiver (RX) processing circuitry, and transmitter (TX) processing circuitry, in accordance with well-known principles.

Processor 440 is capable of executing other processes and programs resident in memory 460. Processor 440 can move data into or out of memory 460, as required by an executing process. Basic operating system 461 includes slotted mode control algorithm 470. According to the principles of the present invention, when MS 102 enters a carrier site 145, processor 440 may execute slotted mode control algorithm 470 upon receiving instructions in paging SCI control message 155 and thereby operate at a reduced paging SCI value or an increased paging SCI value.

FIG. 5 representatively illustrates a logic flow diagram 500 in accordance with an exemplary embodiment of the present invention. In step 502, a BTS receives a plurality of paging request messages for an MS over a paging channel. In step 504, the paging channel utilization is measured, and in step 506 it is determined if the paging channel utilization of the paging channel exceeds a paging channel utilization threshold. If not, the process returns to step 502. If the paging channel utilization threshold is exceeded, then in step 508 it is determined if any of the plurality of paging request messages are being discarded.

If any, or a certain threshold of paging request messages are being discarded, then it is determined if the currently used paging SCI value of the MS is at a minimum paging SCI value per step 510. If so, the process returns to step 502. If not, then the currently used paging SCI value of MS is reduced one step, where one step may be any incremental value of paging SCI value per step 514. If a certain threshold of paging request messages are not being discard in step 510, it is determined if the currently used paging SCI value of the MS is at a baseline or maximum paging SCI value per step 512. If so, the process returns to step 502. If not, then the currently used paging SCI value of MS is increased one step, where on step may be any incremental value of paging SCI value per step 516.

In the foregoing specification, the invention has been described with reference to specific exemplary embodiments. However, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A method of modifying a paging slot cycle index value used by a mobile station in a wireless communication system, comprising:
in a paging area, a carrier site receiving a plurality of paging request messages for the mobile station, wherein the carrier site utilizes at least one paging channel;
measuring a paging channel utilization of the at least one paging channel;
if the paging channel utilization exceeds a paging channel utilization threshold, determining if any of the plurality of paging request messages are being discarded; and
if any of the plurality of paging request messages are being discarded, reducing the paging slot cycle index value for the carrier site.

2. The method of claim 1, further comprising upon the mobile station entering the carrier site, reducing the paging slot cycle index value for the mobile station.

3. The method of claim 1, wherein reducing the paging slot cycle index value occurs only if a currently used paging slot cycle index value is greater than a minimum paging slot cycle index value.

4. The method of claim 1, further comprising upon the mobile station leaving the carrier site, returning the paging slot cycle index value for the mobile station to a baseline paging slot cycle index value.

5. The method of claim 1, wherein the carrier site is a single carrier site.

6. The method of claim 1, wherein the carrier site is a multi-carrier site.

7. The method of claim 1, wherein reducing the paging slot cycle index value comprises reducing the paging slot index to a minimum paging slot cycle index value.

8. The method of claim 1, wherein if none of the plurality of paging request messages are being discarded and the paging slot cycle index value is below a baseline paging slot cycle index value, increasing the paging slot cycle index value.

9. A base transceiver station coupled to transmit paging request messages in a paging area, wherein the paging area comprises at least one carrier site, the base transceiver station, comprising:
a paging slot cycle controller capable of causing the base transceiver station to transmit a paging slot cycle index control message to a mobile station in the at least one carrier site, wherein if a paging channel utilization of the at least one carrier site exceeds a paging channel utilization threshold and one or more of a plurality of paging request messages are discarded, the paging slot cycle index control message causes a mobile station to use a reduced paging slot cycle index value.

10. The base transceiver station of claim 9, wherein the reduced paging slot cycle index value is greater than or equal to a minimum paging slot cycle index value.

11. The base transceiver station of claim 9, wherein if none of the plurality of paging request messages are being discarded and a currently used paging slot cycle index value is below a baseline paging slot cycle index value, the paging slot cycle index control message causes the mobile station to use an increased paging slot cycle index value.

12. The base transceiver station of claim 11, wherein the increased paging slot cycle index value is equal to or less than the baseline paging slot cycle index value.

13. The base transceiver station of claim 9, wherein the carrier site is a single carrier site.

14. The base transceiver station of claim 9, wherein the carrier site is a multi-carrier site.

15. A method of modifying a paging slot cycle index value used by a mobile station in a wireless communication system, comprising:
in a paging area, a carrier site receiving a plurality of paging request messages for the mobile station, wherein the carrier site utilizes at least one paging channel;
measuring a paging channel utilization of the at least one paging channel;
if the paging channel utilization exceeds a paging channel utilization threshold, determining if any of the plurality of paging request messages are being discarded; and
if any of the plurality of paging request messages are being discarded, transmitting a paging slot cycle index control message to the mobile station.

16. The method of claim 15, wherein the paging slot cycle index control message reduces the paging slot cycle index value used by the mobile station to a reduced paging slot cycle index value.

17. The method of claim 15, wherein paging slot cycle index control message reduces the paging slot cycle index value used by the mobile station only if the reduced paging slot cycle index value is greater than a minimum paging slot cycle index value.

18. The method of claim 15, further comprising wherein if none of the plurality of paging request messages are being discarded and a currently used paging slot cycle index value of the mobile station is below a baseline paging slot cycle index value, the paging slot cycle index control message causing the mobile station to use an increased paging slot cycle index value.

19. The method of claim 15, wherein the carrier site is a single carrier site.

20. The method of claim 15, wherein the carrier site is a multi-carrier site.
